(19) United States
(12) Patent Application Publication
(10) Pub. No.: US 2003/0105672 A1
(43) Pub. Date: Jun. 5, 2003

(54) Method and apparatus to facilitate payment over a computer network

(76) Inventors: John B. Epstein, McKinney, TX (US); John L. Smith, Coppel, TX (US); Geron W. Meeks Jr., Houston, TX (US)

Correspondence Address: DAVID NEWMAN CHARTERED, P.O. BOX 2728, LA PLATA, MD, 20646, US

(21) Appl. No.: 09/561,206

(22) Filed: Apr. 27, 2000

Related U.S. Application Data
(60) Provisional application No. 60/143,071, filed on Jul. 9, 1999.

(51) Int. Cl. G06F 17/60

(52) U.S. Cl. 705/26

(57) ABSTRACT

A method an apparatus to facilitate commerce over a computer network wherein a code data base stores codes and associated passwords, both of which may be printed on cards to create money cards. The codes and passwords, or for convenience, a money card, is purchased by a potential consumer desiring to purchase goods or services over a computer network. The data base records the purchase of the money card for either of a particular amount or a variable amount selected by the consumer. To purchase goods or services the consumer utilizes the money card codes and password at any retailer Internet site, accessed via some form of computer network such as the Internet. The retailer computer verifies the validity and balance of the money card when the money card code and password are utilized to purchase goods or services. Upon receipt of authorization from the money card database, the retailer executes the purchase and the money card data base updates the money card balance in the database. In this manner the money card facilitates commerce over a computer network.

### BACKGROUND OF THE INVENTION

1. Field of the Invention

This invention relates generally to network communications and database maintenance and in particular to a system to facilitate Internet commerce.

2. Background

Advances in computer technology and communication technology allow for high-speed computer and communication networks. Simultaneous with the advances in the speed and capability of computer networks other technological advances allow a large percentage of consumers to purchase access, in the form of computers and network service providers subscriptions, to these computer networks. While numerous computer networks exist, one of the most widely known networks is commonly referred to as the Internet. The Internet is a worldwide packet switched computer network having numerous Internet servers, routers and hubs, and can be accessed via personal computers. Numerous individuals throughout the world have access to the Internet via a direct connection or via an Internet service provider. Once connected to the Internet, and in particular, the World Wide Web (WWW) individuals may move from web site to web site to obtain information or download data.

As commonly occurs in modern society, numerous businesses, merchants and retailers have moved to capitalize on this new trend. Business owners and managers have realized the potential of the Internet to increase sales of goods and/or services. Using the Internet consumers can utilize their personal computer and Internet access to connect to a merchant's web site and order goods and services. This frees the consumer from having to travel to and from the store, risk finding the item out of stock, and waiting in line to purchase the goods or service. Hence, the age of Internet retail has emerged.

To hasten the rush of Internet shoppers, merchants have established numerous methods and apparatus to accept payment from a consumer shopping via the Internet. The various payment methods were all adapted to facilitate the transaction. These various methods include payment via credit card, bankcard, personal check or cash-on-delivery (COD).

While it is possible to complete the transactions using these methods, numerous drawbacks exist with regard to each payment option. Indeed, reluctance of consumers or retailers to utilize one or more of these payments methods is hampering the growth of the retail shopping aspects of the Internet. To gain an understanding of the basis for the problem and to highlight the advantages of the present invention, the disadvantages or drawbacks of present payment methods are discussed below.

One drawback of prior art payment methods concerns security. In the case of credit cards, bank cards, and personal checks consumers are concerned that revealing confidential financial information over a computer network may result in the confidential information being compromised either by an unscrupulous merchant or by an unknown computer hacker in search of credit card numbers, bank card numbers, or checking account information.

Another security based issue that limits Internet transactions arises when individuals or family members other than the individual in charge of finances is provided access to financial data such as credit card numbers and the like. By way of example, if a child or worker desires to execute an Internet transaction then the financial information must be given to that person. Such transfer of information may result in excessive Internet purchasing or unauthorized use. Hence, individuals in charge of the financial information, such as a parent or financial department, are reluctant to facilitate the Internet transaction.

One more reason some individuals are reluctant to utilize the Internet as a way to purchase goods or services is because those individuals do not want to be identified with the particular transaction. Use of a credit card, bank card or personal check all provide means to identify the person executing payment and result in some identification of the transaction on a end of the month statement or canceled check. While adult entertainment or goods may be the most common transaction for which anonymity is desired, numerous other transactions may occur more readily if the identity of the purchasing party remains secret. These include but are not limited to the purchase of, personal hygiene products, adult diapers, numerous medical related transactions, contraceptives, dating services, counseling services, and intra-family gifts.

Another reason that the growth rate of Internet commerce is not meeting expectations is due to an inability of many people to qualify for credit cards or bankcards due to lack of income or previous credit problems. Because Internet transactions often depend on the use of a credit card, these consumers are excluded from Internet transactions. Hence, these individuals are presently limited to payment in cash or cashiers check. For Internet transactions, cash and checks are generally not accepted and both unreasonably hinder timely completion of the transaction.

Yet another reason Internet commerce appears to be hesitating arises because a sizable portion of non-Internet transactions involve the purchase of gift certificates, especially near holiday season when other obligations overwhelm many shopper's time resources. However, on the Internet, gift certificates do not commonly exist. A user must most commonly present their credit card number and make an immediate transaction of an item at a particular retailer. For the reasons stated above, a gift giver may not want to provide the gift recipient with their credit card or bank card number or, in the alternative, chose a particular gift for the gift recipient.

Finally, the use of COD payment options is unacceptable to merchants due to the frequency of refusal by consumers to pay upon delivery

Although other methods and apparatus have been proposed to overcome these drawbacks, none have adequately met the existing needs of consumers and retailers. For at least one reason, the other proposed payment methods fail in some respect. For example, many proposed solutions are too complicated in that they require consumers to perform numerous additional steps, actions or application processes. Other proposed solutions do not provide adequate security or anonymity, while other solutions are simply too expensive due to numerous third parties that must be involved to facilitate the transaction.

As will be readily apparent after reading the detailed description that follows in conjunction with the attached Figures, the present invention overcomes the drawbacks of prior art Internet payment methods and apparatus.

### SUMMARY OF THE INVENTION

In accordance with the purpose of the invention as broadly described herein there is provided a transaction system for use in conjunction with a computer network to facilitate consumer transactions. As recited above, the purchase of goods over a computer network, such as the Internet, is a growing economic area. The present invention facilities Internet commerce by providing means for a consumer to purchase goods and services over the Internet without having to use cash, checks, credit cards, or bank cards. Instead of using payment methods of the prior art, the present invention utilized a new transaction method and apparatus. In one embodiment the present invention utilizes codes, which may be imprinted on cards or any other structure or surface. Consumers obtain access to these codes in any number of ways by paying for such codes. Payment may be made using any known method, including but not limited to cash, credit card, bank card, check, money order, award, and gift.

Each code identifies a money card account and the balance of that money card account. For purposes of the present discussion, the term money card and code are used interchangeably. The code may be imprinted on a card or paper, or transmitted via the computer network itself. In one embodiment a single overseeing entity oversees the creation and accounting for each code. This entity oversees the creation of these coded cards, maintains records of the codes with associated balances and serves as a monetary exchange for payments between card (code) purchasers and merchants.

To realize the advantages of the present invention, an individual, such an Internet consumer purchases the card from any of a number of various conveniently locations. It is anticipated that a consumer might conveniently purchase a coded card at a market, convenience store, or computer store. For example, in exchange for cash or check or credit card charge, the retailer provides the consumer with the code or the coded may be printed on a card. The process may be fully automated in that the consumer may obtain the coded card from a vending machine. In one embodiment the card point of sale locations pay the code entity at the time or purchase. In another embodiment the card point of sale locations forward payment for the card to the code entity at the time of purchase of the code.

Having obtained a code, the consumer utilizes codes at any of a number of Internet web sites that accept the code system as associated with the present invention as a form of payment to obtain goods or services. By providing the codes to the web site of the retailer, the consumer facilities a transfer of payment from the code account associated with the card to the merchant. In this manner the Internet merchant or service provider is compensated for the shipment of goods or services to the consumer. The balance associated with the code or card is updated to reflect the purchase. Thus, the amount of the purchase is subtracted. In this manner the code may be reused until the balance in the code account reaches zero. A partial balance can be transferred to another or other cards. Once the account balance is zero, the code account is closed unless the card is “refueled”, and the consumer may no longer obtain goods or services using that particular code.

After the merchant receives payment from the code entity, the merchant or retailer sends the goods to the consumer. It is anticipated that this process may occur rapidly over one or more computer networks.

The above-described method comprises one aspect of the present invention. Another aspect of the present invention comprises the configuration of apparatus and hardware. In one embodiment the present invention may be enabled using a computer server having communication apparatus in communication with a computer network, such as the Internet. Also included at the server is one or more storage mediums, such as a hard disk drive, configured to store at least software of the present invention to facilitate Internet commerce and code data management. At least one user interface is in communication with the server to provide control over the software and data.

In operation, the data concerning each code is stored on the storage medium of the server, such as on a hard drive. These codes, created according to the present invention with aid of any operator, are initially sold to a code point of sale location or individuals who sell the codes via telephone, web sites, or vending machines. The codes may be imprinted on cards.

Thereafter, the codes are sold to consumers or businesses for use over the Internet. When the codes are sold to a consumer or business, the code is activated when logged onto the server for use and may thereafter be provided to a web site of a retailer or service provider to obtain goods or services. It is anticipated that one manner in which the code is provided to the retailer or service provider is via the Internet, in person, or via telephone.

After the consumer provides the code to the retailer web site the retailer web site utilizes one or more computer networks to verify that the code is valid and that the balance associated with the code is sufficient to cover the desired purchase. If the purchase is authorized the balance is adjusted to reflect the purchase and the funds transferred from the card account to the retailer or service provider. Once paid for, the retailer or service provider ships or provides the goods or services to the purchaser. In this manner transactions occur.

The concepts of the present invention possess several advantages over the prior art. The present invention provides means for a consumer to shop on the Internet for goods and services while still maintaining secrecy as to their identity. Likewise, the user of the code is limited to purchases that do not exceed the balance of the code (although additional funds may be added by the user). Further, the code may be purchased with cash by an individual who does not qualify for a credit card or checking account. The cards are distinguished from “smart cards” and no readers or embedded chips are required. Finally, the code may be presented as a gift, such as in the form of a gift certificate, to a party who may then chose to purchase any item on the Internet. Those of ordinary skill in the art will realize other advantages not discussed herein.

### BRIEF DESCRIPTION OF THE DRAWINGS

FIG. 1 is a block diagram illustrating the relationship between various aspects of one embodiment of the present invention.

FIG. 2 illustrates an exemplary money card as might be utilized with the present invention.

FIG. 3 illustrates a block diagram of one example embodiment of the present invention.

FIG. 4 illustrates various types of money cards.

FIG. 5 illustrates exemplary data fields in an example embodiment of a card database.

FIG. 6 illustrates exemplary data fields in an example embodiment of a merchant database.

FIG. 7 illustrates exemplary data fields in an example embodiment of a promotion database.

FIG. 8 illustrates exemplary data fields in an example embodiment of a transaction database.

FIG. 9 illustrates exemplary data fields in an example embodiment of a card sales database.

FIG. 10 illustrates a relational flow diagram of one exemplary method of use of a card having a code in one embodiment of the present invention.

FIGS. 11A and 11B illustrates an operational flow diagram of one example method of operation of the present invention.

FIG. 12 illustrates an operational flow diagram of one example method of operation of a guaranteed click through feature of the present invention.

FIG. 13 illustrates an operational flow diagram of one example method of operation of a promotions sub-routine of the present invention.

FIG. 14 illustrates an exemplary card “refilling” or “refueling” system.

FIG. 15 shows an alternative card layout.

### DETAILED DESCRIPTION OF THE PREFERRED EMBODIMENTS

1. Overview of the Invention

The present invention provides improved systems and methods for facilitating the purchase of goods or services over a computer network. As recited above, the purchase of goods over a computer network, such as the Internet, is a growing economic area. The present invention facilities Internet commerce by providing a system and method for a consumer to purchase, using any payment method, digital money cards. Each card includes one or more codes that identify that money card account and the balance of that money card account. For purposes of the present discussion, the term money card and code are used interchangeably. The code may be imprinted on a card or paper, or transmitted via the computer network itself. In one embodiment a single overseeing entity oversees the creation and accounting for each code. For purposes of understanding, this overseeing entity is referred to herein as a money card exchange. The money card exchange oversees the creation of these coded cards, maintains records of the codes with associated balances and serves as a monetary exchange for payments between card (code) purchasers and merchants.

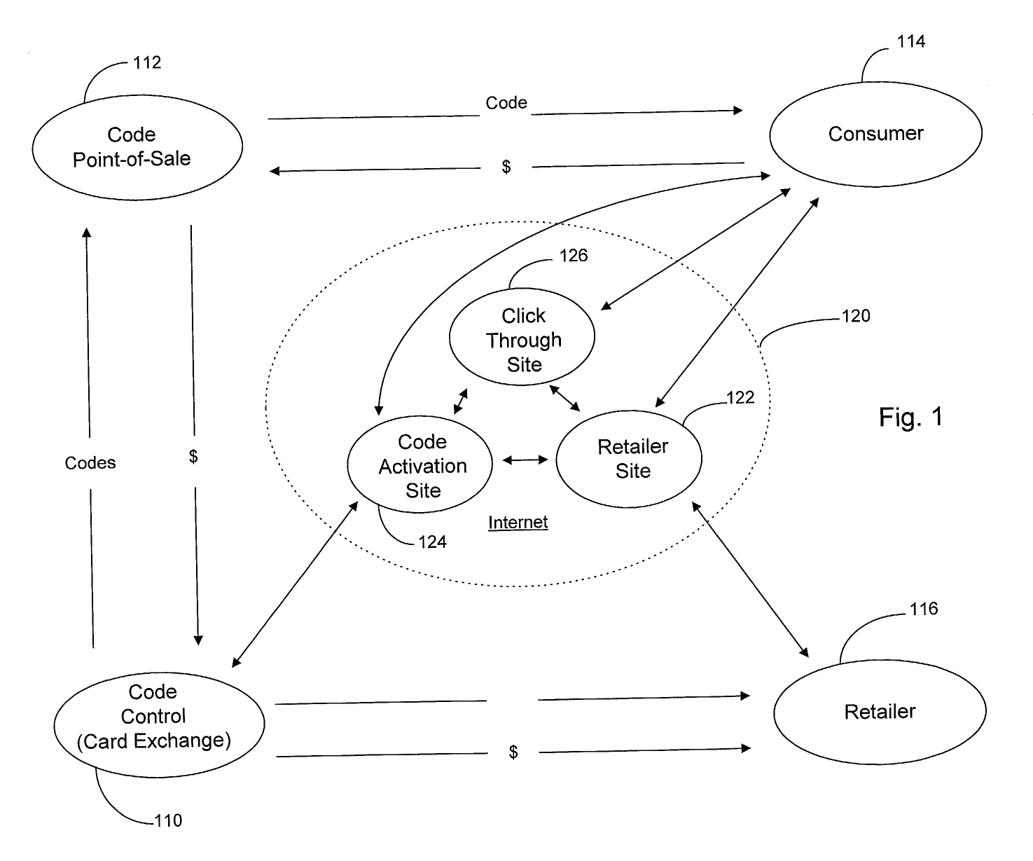

Turning now to FIG. 1, to realize the advantages of the present invention, an individual, such as an Internet consumer purchases the card from any of a number of various convenient locations, referred to herein as a money card point-of-sale 112. It is anticipated that a consumer might conveniently purchase a coded card at a market, convenience store, or computer store. For example, in exchange for a 50 dollar money card having a 50 dollar money code, a consumer would provide the card retailer with adequate renumeration in any form of accepted payment including but not limited to cash, credit card, check, or COD.

Having obtained a code, the consumer may utilize this code at any of a number of Internet web sites as a form of payment to obtain goods or services from a merchant. By providing the codes via the Internet to the web site of the retailer, the consumer facilitates a transfer of payment from the code account to the merchant. In one embodiment the money card exchange maintains the code account and ensures payment from the code account to the merchant. Likewise, the money card exchange maintains and updates the available balance associated with each code. In this manner the code may be reused until the balance in the code account is depleted. Once the account balance is zero, the code account is closed unless the card is refueled, and the consumer may no longer obtain goods or services using that particular code. The balance in several cards can be consolidated if desired.

Additional details regarding the use of the money card code system and the systems that enable such use are described below in greater detail.

2. Example Environment

One example environment particularly well suited for use of the code system of the present invention is the Internet. As is commonly known in the art, the Internet comprises a world-wide network of computers configured to exchange, store and display information. Located on the storage media of the plurality of computers that comprise the Internet is data and code to facilitate the display of information, such as web pages, to individuals having access to the Internet. Internet access, i.e. getting “on-line,” is most commonly provided via an Internet service provider such as America-On-Line or Earthlink.

Retailers maintain numerous web pages on the Internet in an effort to sell goods and services. These web pages include interactive software to facilitate payment for goods purchased by consumers.

In reference to FIG. 1, a block diagram of the various aspects of the present invention are shown. A money card exchange 110 is responsible for the establishment of codes, which in at least one embodiment, are imprinted on cards. The money card exchange 110 maintains a data base of code numbers with an associated balance for each code. Each code or card has a money value associated therewith. The operation of the money card exchange 110 is discussed in greater detail below.

The money card exchange 110 communicates with a money card point of sale 112. It is anticipated that the money card point-of-sale can comprise a convenience store, retail store, vending machine, on-line vendors, mail order or by telephone. The money card exchange 110 sells large numbers of money cards, i.e. codes, or cards imprinted with codes to the money card point-of-sale 112. Hence, codes are exchanged for payment to the money card exchange 110 either at time of sale to the retailer or after sale to a consumer.

The money card point-of-sale 112 in-turn sells the money cards having codes associated therewith to individual consumers 114. The consumer 114 thus provides payment to the point-of-sale 112 equal to greater than or less than the denomination of the money card.

Next, the consumer utilizes a computer network, such as the Internet 120, to access a particular computer database or web site. In one embodiment the web site is a retailer site 122 that is maintained by a retailer 116. The retailer site 122 includes software capable of accepting the code as a form of payment for goods or services. In various embodiments the consumer accesses any of a code activation site 124, the retailer site 122, or a click-through-site 126. The click-through-site 126 comprises a web site configured to interface with the code activation site 124 to thereby generate consumer traffic to the click-through-site.

After the consumer activates the code in the code database at the money card exchange 110, the consumer may direct their computer to a web site, such as a retailer site 122, to utilize the code to purchase goods or services.

Upon purchase of goods or services at a retail site, the retail site 122 notifies the retailer 116 and the money card exchange 110 via the Internet. In response, the money card exchange 110 provides payment to the retailer 116. In this manner the retailer receives payment for the goods and services. The money card exchange 110 automatically deducts the purchase price from the balance of the money card.

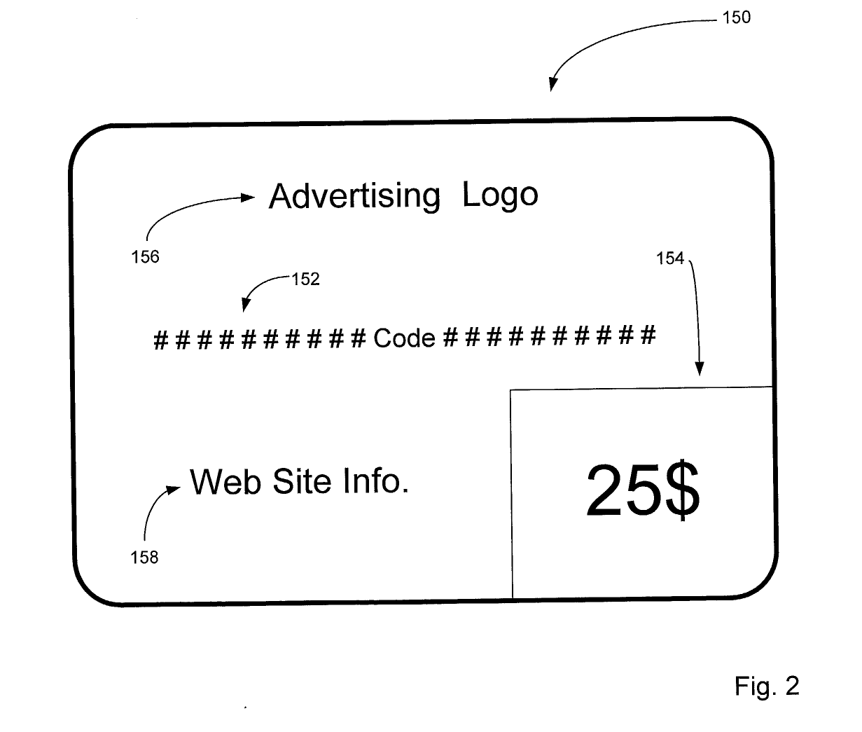

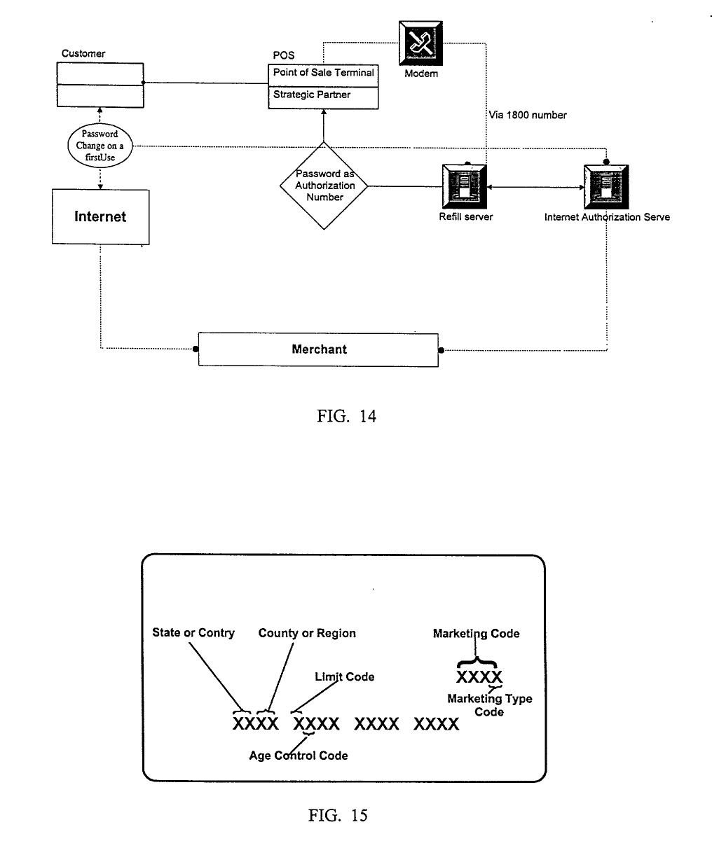

Turning now to FIG. 2, a top plan view of an exemplary money card 150 is shown. As shown, the money card 150 includes a code 152 which may be utilized to obtain goods and services. The code may either be printed or imprinted on the face of the card. The card also includes a denomination or value 154 representing how much the card costs or is worth. In alternative embodiments, some form of advertising logo 156 resides at the top of the card and instructions or an Internet web site address 158 also resides on the money card 150. Various other embodiments of the present invention place the code on items other than a card. For example, the code may be purchased via on on-line service and delivered to the purchaser in an encripted digital format. In other embodiment the code is placed on other items including but not limited to paper, e-mail, telegrams, phone messages, or any promotional items. FIG. 15 shows another card layout.

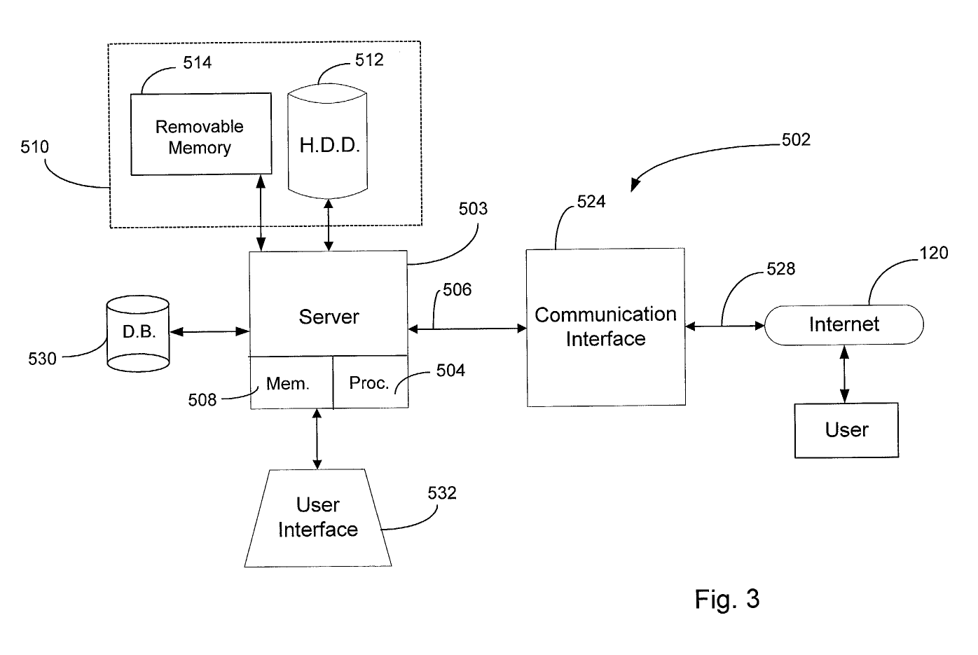

In reference to FIG. 3, the apparatus of the user interface is described in more detail. The various embodiments, aspects and features of the invention described herein may be implemented using hardware, software or a combination thereof and may be implemented using a computing system having one or more processors. In fact, in one embodiment, these elements are implemented using a processor-based system capable of carrying out the functionality described with respect thereto. An example processor-based system 502 is shown in FIG. 3 according to one embodiment of the invention. The computer system 502 includes one or more processors, such as processor 504. The processor 504 is connected to a communication bus 506. Various software embodiments are described in terms of this example computer system. The embodiments, features and functionality of the invention as described above are not dependent on a particular computer system or processor architecture or on a particular operating system. In fact, after reading this document, it will become apparent to a person of ordinary skill in the relevant art how to implement the invention using other computer or processor systems and/or architectures.

Processor-based system 502 having a server 503 with a main memory 508, preferably random access memory (RAM), and can also include a secondary memory 510. The secondary memory 510 can include, for example, a hard disk drive 512 and/or a removable storage drive 514, representing a floppy disk drive, a magnetic tape drive, an optical disk drive, etc. The removable storage drive 514 reads from and/or writes to a removable storage medium (not shown) in a well known manner. Removable storage media, represents a floppy disk, magnetic tape, optical disk, etc. which is read by and written to by removable storage drive 514. As will be appreciated, the removable storage media includes a computer usable storage medium having stored therein computer software and/or data.

In alternative embodiments, secondary memory 510 may include other similar means for allowing computer programs or other instructions to be loaded into computer system 502. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from a removable storage unit to computer system 502.

Computer system 502 can also include a communications interface 524. Communications interface 524 allows software and data to be transferred between computer system 502 and external devices via a network such as the Internet. Examples of communications interface 524 can include a modem, a network interface (such as, for example, an Ethernet card), a communications port, a PCMCIA slot and card, etc. Software and data transferred via communications interface 524 are in the form of signals which can be electronic, electromagnetic, optical or other signals capable of being received by communications interface 524. These signals are provided to communications interface via a channel 528. This channel 528 carries signals and can be implemented using a wireless medium, wire or cable, fiber optics, or other communications medium. Some examples of a channel can include a phone line, a cellular phone link, an RF link, a network interface, and other communications channels.

In this embodiment the communication interface 524 connects to the Internet 120 or some other computerized network capable of exchanging information, such as codes, to other computers to thereby facilitate commerce.

A data base 530 is in communication with the server. As known by those of ordinary skill in the art, the data base 530 stores and retrieves records based on record numbers or some other identifier. The data base 530 stores code numbers, associated balance information, and other information. The information stored in the data base 530 is discussed in more detail below.

A user interface 532 connects to the server 503 to provide means for a money card employee or system operator to interface with the software running on the server 503, database 530 and communication interface 524. In one embodiment the user interface 532 comprises a video display unit, a keyboard, and a graphical interface device, such as a mouse or trackball.

In this document, the terms “computer program medium” and “computer usable medium” are used to generally refer to media such as removable storage device, a disk capable of installation in disk drive 512, and signals on channel 528. These computer program products are means for providing software or program instructions to the computer system 502.

Computer programs (also called computer control logic) are stored in main memory 508 and/or secondary memory 510. Computer programs can also be received via communications interface 524. Such computer programs, when executed, enable the computer system 502 to perform the features of the present invention as discussed herein. Accordingly, such computer programs represent controllers of the computer system 502.

In an embodiment where the elements are implemented using software, the software may be stored in, or transmitted via, a computer program product and loaded into computer system 502 using removable storage drive 514, hard drive 512 or communications interface 524. The control logic (software), when executed by the processor 504, causes the processor to perform the functions of the invention as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to persons skilled in the relevant art(s). In yet another embodiment, elements are implemented using a combination of both hardware and software.

This is but one of many different configurations that may be utilized to embody the present invention. Other configurations of hardware are fully contemplated by the present invention.

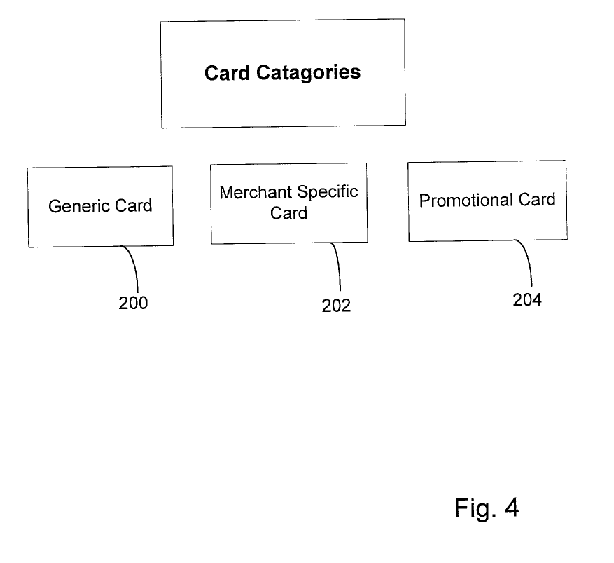

FIG. 4 presents several categories into which money cards are grouped depending on the features of the money cards. While all money cards and associated network configured in accordance with the present invention share a basic method of operation, different types of money cards do exist. One type of money cards comprise generic money cards 200. A generic money card is a basic money card that can be used at any Internet Site that accepts the money card method of payment.

Another type of money card can comprise merchant specific money cards 202. A merchant specific money 202 card differs from a generic money card 200 in that it must be used at a specific Internet web site.

Another type of money card comprises a promotional money card. A promotional money card 204 comprises a money card specifically associated with one or more other promotions or incentives to utilize the money card at a particular site or for a particular type of product or service. The card may be without cash value and be promotional only (like a coupon). For example, in some cases cards can be distributed via magazine or direct mail or hand outs. The cards usually will not have a value. The recipient will then take the cards into a strategic approved “fuel retailer” like Wal-Mart or Blockbuster to “refuel” with money. They simply hand over cash to the person at the register and their card. The person at the register swipes the card magnetic strip into the credit/debit card reader machine and enters the amount the person gave them (i.e. $25, $50, $500 etc.) into the cash register/reader. The transaction goes through to Wal-Mart, Blockbusters, etc. severs to the server of the present system which completes the fuel transaction and gives the card value. The recipient then can go to any web site that accepts the card and use it.

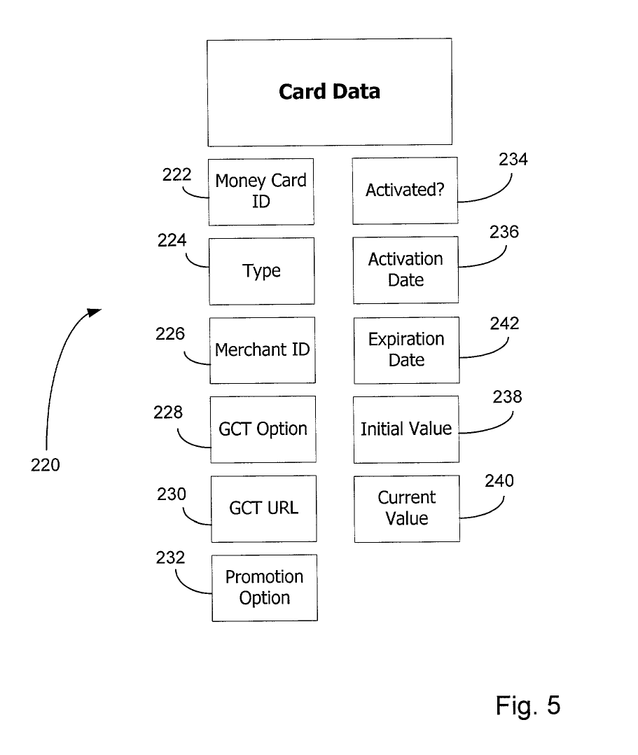

FIG. 5 illustrates the organization and content of the data base records and sub-records of one exemplary embodiment of the present invention. In this exemplary data base configuration, the data is divided into five main categories. For purposes of explanation and understanding, these categories and the data associated with each are discussed herein. The five exemplary categories are money card data 220, merchant data 246, promotions data 256, transactions data 270, and card sales data 300. Each of these categories is discussed below in greater detail.

Card Data

One aspect of the data base data comprises card data 220. Card data 220 comprises data stored by the present invention that concerns the money card or the code on the card. In this exemplary embodiment, the data broadly categorized as card data includes a money card ID 222. The money card ID 222 comprises the code entered by a consumer to obtain goods or services. This code identifies the card and is the primary identifier of the account. The card category 200 of data also includes the money card type 224 to identify whether the card is a generic 220, a merchant specific 202, or a promotional money card 204.

A merchant ID 226 uniquely identifies, with an identification number, each merchant and their web site that is configured to accept money card transactions. This ID is used to track transactions to a merchant and to facilitate transfer of funds to the merchant.

A click-through-option enabled flag 228 in the money card category identifies whether the consumer must access a particular retail web site to activate the card. A click-through-option URL 230 identifies the URL of the click-through site. A promotion option data field 232 stores data regarding which promotion, if any, is associated with the card.

An activation completed field 234 and an activation date field 236 identify if a consumer has activated the money card and, if so, on what date. An expiration date field 242 identifies the date of expiration of the card, if such a date has been requested.

An initial value field 238 stores the initial monetary value of the card while a current value field 240 stores the current available balance or value of the card based on previous purchases.

Merchant Data

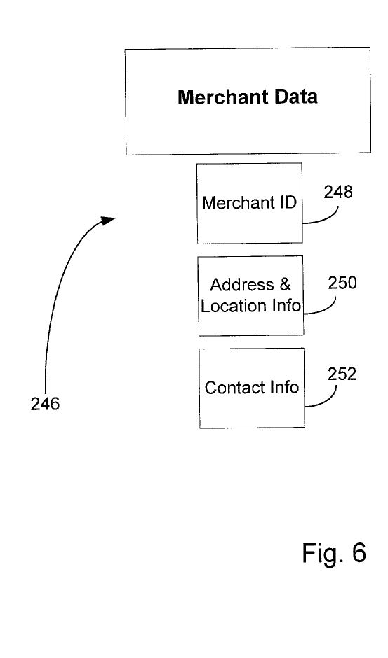

As shown in FIG. 6, the merchant data category 246 comprises data fields specific to each particular merchant that utilized the money card system. The fields of the merchant data category comprise merchant id field 248, described above, an address field 250 to store the address information regarding each particular merchant, and contact information field 252 to store payment information.

Promotions Data

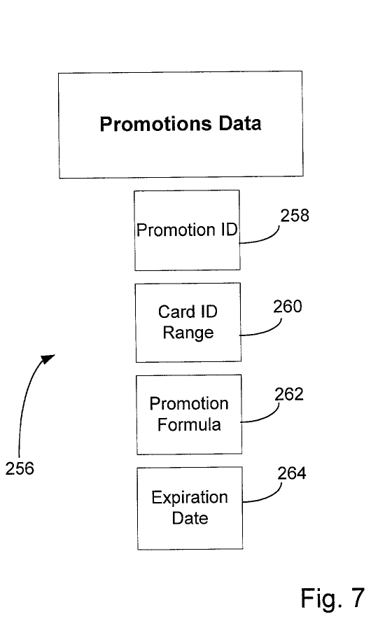

As shown in FIG. 7, the promotions data fields 256 store data regarding the promotions available and the promotions associated with each money card. A promotions ID field 258 identifies a particular promotion with an identifying code. The promotions ID 258 is used to identify a particular promotion. A money card ID range 260 identifies the money cards, by money card ID (code) that are issued under a particular promotion. In one embodiment a particular range of cards is assigned a particular promotion.

The promotion formula field 262 identifies the particular promotion associated with each promotion or promotion ID such as 10% off all purchases, or buy one get one for ½ price. Of course, these promotions are listed by way of example and not limitation. More complex promotions may be utilized as desired. An expiration data field 264 identifies the expiration of the particular promotion.

Transactions Data

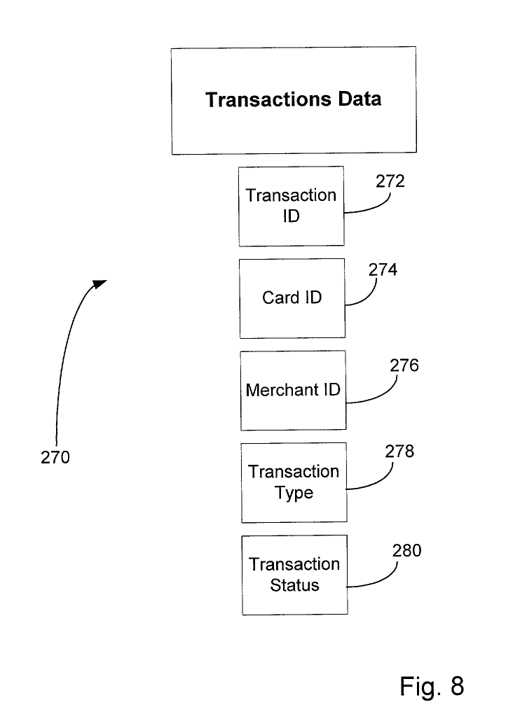

As shown in FIG. 8, the transactions data 270 contains information regarding transactions that have occurred for a money card. The system tracks the transactions for each money card thereby maintaining detailed records of card balance and merchant payment amounts. A transactions ID 272 and associated money card ID 274, both of which are fields in the transactions data category 270 uniquely identify each transaction. A transaction type field 278 stores data identifying the type of transactions, including whether it is a purchase, return, or use of a promotion item. A transaction status field 280 stores information identifying the status of each particular transaction.

Money Card Sales

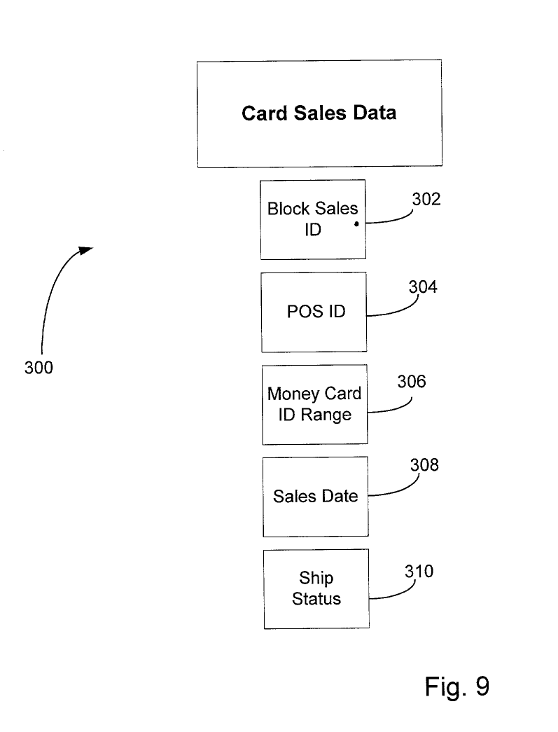

As shown in FIG. 9, the money card sales category 300 stores data regarding the sale of cards or codes to point-of-sale locations. For every sale of cards to a point-of-sale location a block sales ID field 302 is used to identify which card numbers were sold to a card seller. A point-of-sale ID field 304 stores a numeric code that uniquely identifies the point-of-sale location or entity to which the money cards were sold.

A money card ID range 306 identifies the range of money card codes that were sold in the money card transaction identified by the unique block sale ID 302. A sales date field 308 and a card shipment status field 310 store data regarding the date of sale and shipping information.

This manner of data is utilized by the money card system during operation. The functionality and importance of the various types of data are discussed in more detail below.

Operation

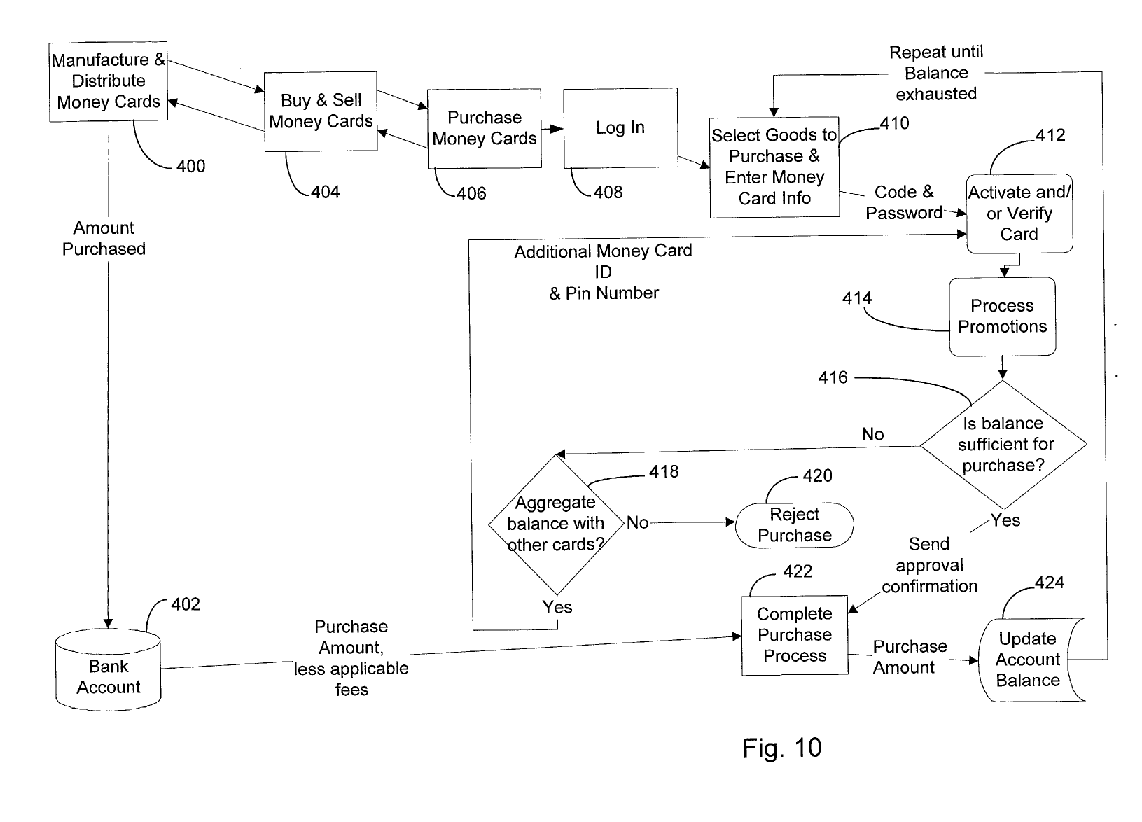

It is contemplated that various methods of operation may be adopted in conjunction with the present invention. FIG. 10 illustrates one exemplary method for establishing and utilizing one embodiment of the present invention. The present invention is not limited to the method illustrated in FIG. 10 as various other methods and system may be used to implement the process.

At an event 400, cards are manufactured and distributed or sold to various point-of-sale locations. As renumeration for the sale of the cards, the point-of-sale locations deposit money in a bank account 402 or remuneration may not occur until sale to the consumer or upon processing. In various other embodiment the present invention may utilize items other than cards on which to distribute the codes and passwords utilized in the system of the present invention. In one embodiment the codes and passwords are delivered electronically or printed on paper, other promotional devices or sent via fax or phone. The term money card is used herein for purposes of conveniences, to broadly represent any form of code and/or password.

At an event 404 the purchase and sale of the money cards occurs as point-of-sale locations purchase the cards from the card exchange 400. Next, at an event 406, consumers desiring to use the money cards pay point-of-sale locations for the codes and passwords used to purchase goods or services over a computer network.

It is contemplated that such purchases may occur via a computer network, via telephone, or in-person at the site of the point-of-sale. In one configuration, the card is automatically active at the time of sale or transfer to the point-of-sale location. In another configuration the card is activated at the first time of use for the purchase of goods or services at a retailer or merchant.

In other embodiments it is contemplated that an independent step of activation can be utilized. Thus the consumer utilizes the connection with the computer network to activate the money card code in the money card data base. Accordingly the money card site provides the money card code and/or password to the money card data base via the computer network. Upon activation the money card may be used to purchase goods or services from any retailer or merchant accepting the money card as a form of payment.

At an event 408, a consumer who owns the card logs into a network. At an event 410 the consumer selects goods to purchase and enters money card information. At an event 412, the system activates and verifies the code on the card.

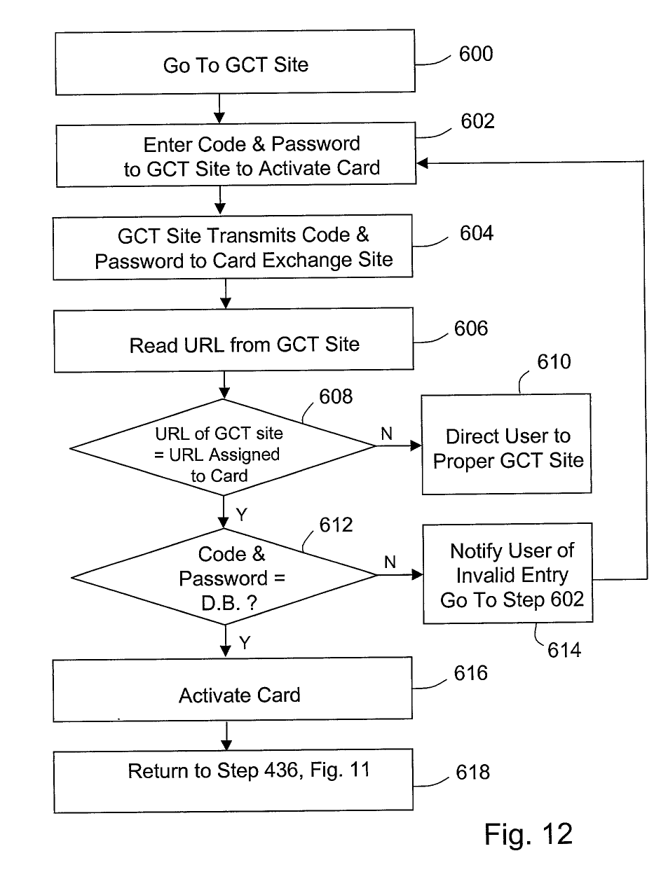

Next, at an event 414, the money card system processes any promotions associated with the card or the purchase of goods or services being obtained with the money card. FIG. 13, discussed below, discusses one exemplary method of promotion processing in greater detail.

Next, at an event 416, the operation determines if the balance of the card is sufficient to complete the purchase. To determine if the balance of the money card is sufficient, the operation interrogates the money card data base to obtain balance information. If the balance is not sufficient to complete the purchase, the operation progresses to an event 418, wherein other forms of payment may be utilized to supplement payment. In various other embodiments other payment methods that may be utilized include but are not limited to additional money cards, credit cards, bank cards or direct bill procedures. If adequate payment can not be provided, the operation terminates the purchase at an event 420.

If sufficient balance is available on the card or if additional forms of payment have supplemented the payment, the operation progresses to event 422 wherein the approval of the purchase is sent from the money card site to the retailer or merchant site so the purchase may be completed.

Thereafter, the account balance on the card is updated, event 424, and appropriate amount of money is sent from the money card account 426 to the retailer in exchange for the purchase of the goods or services.

This is but one of many various general methods of operation for the establishment of money cards, purchase of money cards, use of money cards, and verification process during money card use. It is contemplated that those of ordinary skill in the art will envision other methods of use or variations on the described method of use, all of which are covered by the scope of the claims below.

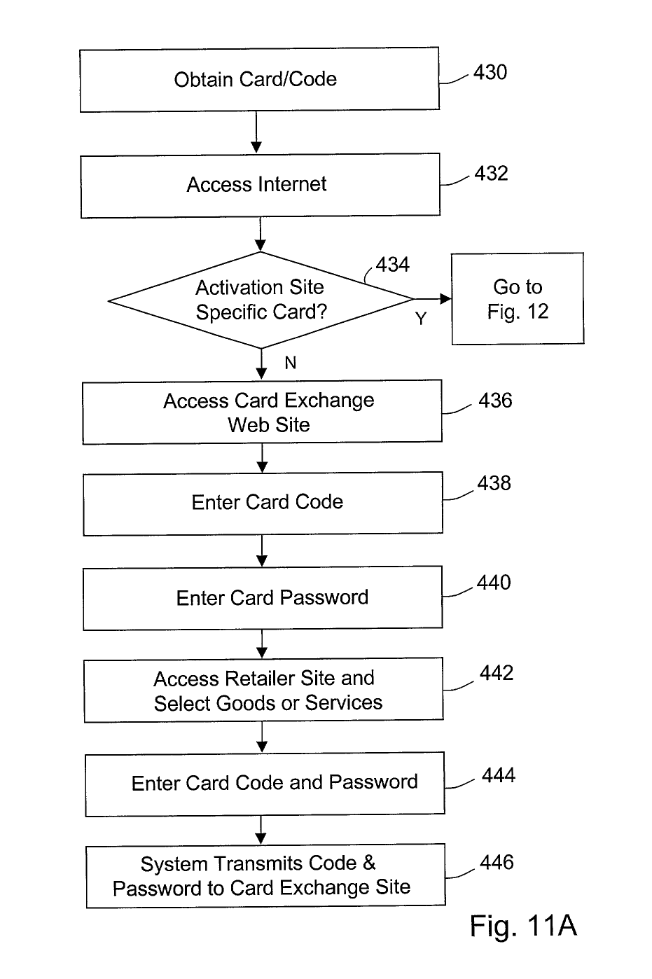

FIG. 11 illustrates an operational flow diagram of detailed exemplary method of operation of the present invention from the stand point of a user or purchaser of a money card or money card codes. At a step 430, a user of the money card system obtains a card. It is contemplated that the card may be provided in any number of ways including but not limited to purchase, gift, or prize or as a free promotion.

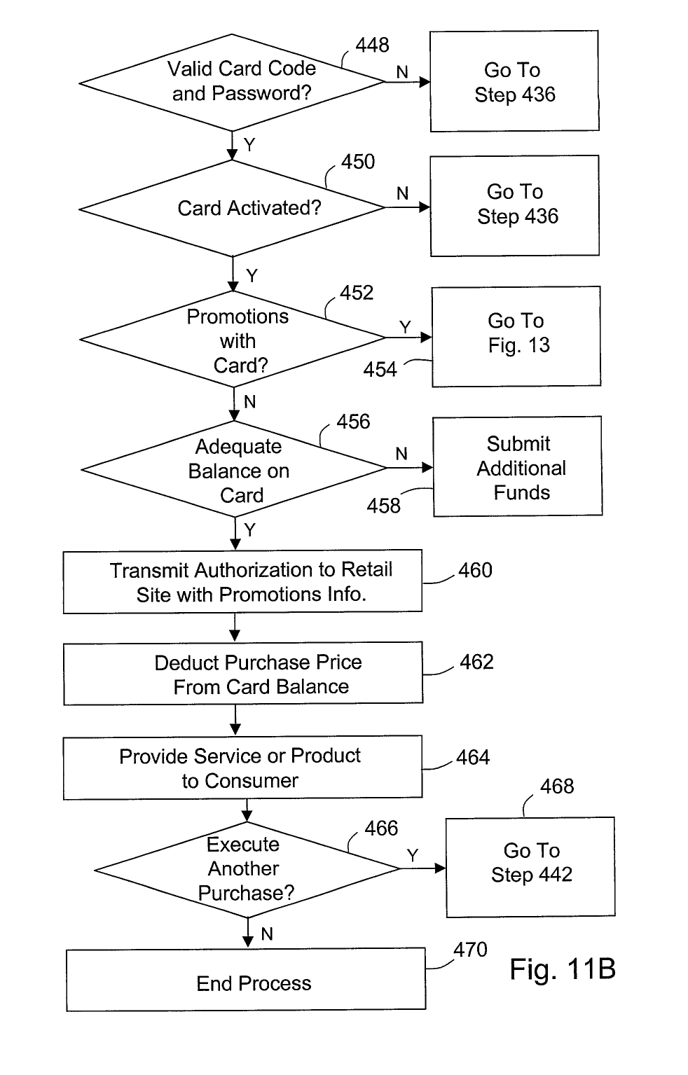

Next for a user intending to utilize the money card over a computer network such as the Internet, at a step 432, the user accesses the Internet. Next at a step 424, the user determines if the money card has been designated as a money card having the guaranteed-click-though option (hereinafter GCT). If at step 434 the user determines the card to be a GCT card, the operation progresses to the GCT sub-routine. One exemplary method of operation of the GCT sub-routine is provided in FIG. 12 and the associated text. In summary the GCT feature that may optionally be associated with a money card requires that the money card be activated from a particular Internet site. In various embodiments the GCT site may be any site having activation software or links and desiring to obtain additional Internet traffic. In at least one embodiment the GCT site that a money card user must first go to activate the card comprises the Internet site of an Internet retailer. Advantageously, an Internet retailer established as a GCT site obtains Internet traffic at their retail web site from consumers having recently activated money cards, i.e. Internet cash to spend.

Subsequent to the GCT sub-routine or if the money card is not a GCT money card, the operation progresses to a step 436 wherein the user directs their communication software to access the Internet to enter the money card Internet site. At a step 438 and a step 440, the user enters the money card code and associated money card password for that card and transmits the code and password to the money card Internet site from the user software. It is contemplated that in the embodiment discussed herein each money card includes a code that is used to identify that particular money card and a password that is also supplied with the card. The password serves as a secondary form of security to further limit an unauthorized person from utilizing the money card. The password may be supplied separate from the money cards, such as on paper or by telephone, or may be printed on the money card or near the money card code.

After activating the money card the user accesses a desired Internet site to purchase goods or services. This occurs at a step 442. At the site the user also selects goods and services they desire to purchase. Upon selecting the goods the user is prompted to enter payment information. In versions of retail Internet sites, the money card system if one available method of payment. In such a situation the user selects the money card as the desired payment method and enters the money card code and password at a step 444.

At a step 446, the retail site records the code and password and forwards data to the money card Internet site including but not limited to the money card code, password, merchant ID code, and purchase price of item.

At a decision step 448, the operation at the money card site determines whether the code and password presented are valid. If the code is not valid the operation progresses to a step 436 wherein the process informs the user of the invalid card number and/or password.

If the card number and password are determined to be valid, the operation progresses to a decision step 450 to determine if the money card has been activated. If the card has not been activated, the operation progresses to a step 436 wherein the user is notified of the need to activate the money card. It is contemplated that the system may supply the user with the ability in the form of Internet links to access a money card activation site.

If at step 450 the card has been activated then the operation progresses to a decision step 452 to determine if the card or purchase has an associated promotion. If at decision step 452 the operation determines there is a promotion associated with the transaction the operation progresses to a step 454 to execute a promotions sub-routine. The promotion sub-routine step 454 is discussed in more detail below in conjunction with FIG. 13.

If at decision step 452 there is no promotion associated with the transaction then the operation progresses to a decision step 456 wherein the operation compares the balance on the card to the amount of the purchase. If the balance on the money card is not adequate to cover the purchase, then the operation progresses to a step 458 wherein the system prompts the user concerning the deficiency. In various embodiments the user may then reconfigure his purchase such that the amount of the purchase is within the balance of the card or use some other form of payment to supplement the amount of the purchase. It is contemplated that these supplemental forms of payment may include additional money cards, credit cards, checks, bank cards, personal checks, purchase order numbers, or send-a-bill requests.

Alternatively, if the balance on the money card is sufficient to pay for the purchase the operation progresses to a step 460 wherein the system transmits an authorization code via the Internet to the retailer's Internet site. The authorization code indicates to the retail site that the money card is a valid payment method. In various configurations, additional other information is sent to the retailer's Internet site such as the purchase price after promotions, the item's code, date of purchase, the retailer security code and any other information required by the retail establishment to be able to process the transaction.

At a step 462, the money card site deducts the purchase price from the balance of the money card. This preferably occurs only after the retailer site has received instructions that the transaction is complete. In other embodiments step 462 occurs simultaneous with authorization transmission (step 460) to the retailer computer.

At a step 464, a process is initiated to provide the purchased goods or services to the consumer. This may comprise, but is not limited to, shipping the goods, ordering the goods to be made, or providing an authorization code to the consumer to obtain the goods or services.

Next, at a decision step 466, the operation requires the consumer to determine if another purchase is to be made. If the consumer chooses to make another purchase, step 468, the operation returns to a step 442. If the consumer chooses not to make another purchase the operation progresses to a step 470 and the operation terminates. The user or consumer is then free to exit from the computer network or go to another computer network site.

Turning now to FIG. 12, an operational flow diagram of the guaranteed-click-through (GCT) sub-routine is illustrated. The GCT sub-routine is referenced in step 434 of FIG. 11 and is utilized if the money card is designed as a money card with the GCT option. The GCT option comprises a requirement that the particular card be activated, or the first purchase made, at a particular computer network site, such as a particular Internet web site. The GCT option thus provides the advantage of channeling Internet traffic to a particular site. The GCT option provides the further advantage of channeling traffic to an individual Internet site that is ready and able to make Internet purchases.

In reference to FIG. 12, at a step the user accesses the GCT site. In one embodiment the GCT site is identified on the face of the money card. Upon accessing the GCT site 600, the user enters the money card code and password using an access computer and transmits this information to the money card site. This occurs at a step 602.

Next, at a step 604, the GCT site contacts and transfers the code and password from the user to the money card site. The money card site uses this information to verify the accuracy of the submitted money card data and to activate the money card for use at any Internet site. At a step 606, the operation also obtains the Uniform Resource Locator (URL) information from the GCT site. As known by those of ordinary skill in the art, the URL is a unique identifier for a particular site on the Internet, in this case, the GCT site. The URL is divided into parts or sections. The first part of the URL indicates the type of transfer protocol used to retrieve information. The second part of the URL refers to the specific host computer on which the information resides. The third part of the URL is the directory on the host computer that contains the specific Internet web site. The parts or sections are most often divided by back slash (/) characters.

At a decision step 608, the operation determines if the URL of the GCT site matches the URL assigned to the money card having the password and code provided. If the URL does match the URL of the GCT site assigned to the card having the provided code then the user is not utilizing the proper GCT site. As a result, the operation progresses to a step 610, wherein the user is provided a message or directed to the proper GCT site automatically.

If the user utilizes the proper GCT site the operation progresses to a decision step 612 wherein the money card site evaluates the code and password or authenticity and validity. If the money card code does not match the money card password, as compared to the information in the money card database, the operation progresses to a step 614 so that the user may be notified of the invalid entry and the operation returns to step 602.

Alternatively, if the operation determines at decision step 612 that the code matches the password, then the operation activates the card at a step 616. This completes the GCT option sub-routine. The operation returns to a step 436 as shown on FIG. 11.

FIG. 13 illustrates an operational flow diagram of an exemplary method of operation of the promotions sub-routine. The promotions sub-routine is designated generally at step 454 of FIG. 11. Turning now to a detailed discussion of one example method of operation that occurs when a card or transaction is designated as having a promotion associated with it. After having determined that a promotion is associated with the purchase, as shown in step 454 of FIG. 11, the operation begins the promotions sub-routine. At step 650, the operation obtains promotion data that is associated with the code, password, or proposed purchase from the card database. Promotion data may include but is not limited to data regarding the type of promotion, such as percentage discount, free gift with purchase, award of purchase coupons or award points, cash back award. The promotion data may also comprise data regarding the start date and expiration date of the promotion, the sponsor of the promotion or contact information regarding the promotion.

Next, at a step 652, the operation calculates the effect of the promotion on the purchase. The effect of the promotion may comprises a percentage discount or some other form of adjustment to the purchase. Next at a step 654 the operation applies the promotion to the price of the purchase or some other aspect of the purchase. This price or transaction summary is utilized for the basis of the purchase.

Next, at a step 656, the operation records the promotion data and associated transaction in a database. Thereafter, at a step 658, the operation includes the promotion data and adjustment in transaction price in the authorization data that is to be sent to the retail site. The promotions sub-routine operation then returns to the operation of FIG. 11 at a step 454.

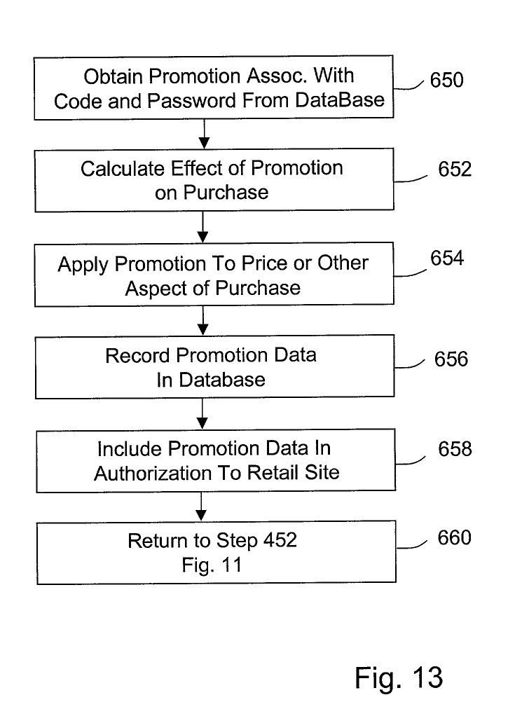

FIG. 14 shows an exemplary card refilling or fueling system which is self explanatory. FIG. 15 shows an alternative card layout wherein X's 1-6 are as labeled and X's 7-16 are the card member. The marketing code identifies a merchant, and the marketing type code identifies, e.g. mail, partner, Internet, etc.

While particular embodiments and examples of the present invention have been described above, it should be understood that they have been presented by way of example only and not as limitations. Those of ordinary skill in the art will readily appreciate that other various embodiments or configurations adopting the principles of the subject invention are possible. The breadth and scope of the present invention is defined by the following claims and their equivalents, and is not limited by the particular embodiments described herein.

What is claimed is:

1. A method for an individual to purchase goods over a computer network using a cash money card comprising;
obtaining at least one code from a retailer in exchange for payment to a code retailer;
accessing a first web site via a computer network, said web site configured to accept said at least one code;
entering said at least one code to said first web site whereby said first web site activates said at least one code;
accessing a second web site via a computer network, said second web site configured to offer merchandise for sale and accept said at least one code; and
entering said at least one code at said second web site as payment to obtain said merchandise.

2. The method of claim 1 wherein said first and second web site comprises data stored on a computer, the data being assessable from the Internet.

3. The method of claim 1 wherein activating said at least one code includes communicating to a code data base over the computer network that said at least one code is activated.

4. The method of claim 1 wherein said at least one code has an account balance associated therewith, wherein said account balance is generally the amount provided to said code retailer.

5. The method of claim 1 wherein said code retailer comprises a vending machine configured to accept credit cards as a form of payment for said at least one code.

6. A method for a merchant to sell goods or services to a purchaser via a computerized network wherein the identity of the purchaser remains unknown to the seller, the method comprising;
receiving a code from a purchaser, the code not identifying the purchaser;
analyzing the code to determine if the code is valid;
verifying that a balance associated with the code is sufficient to pay for the goods or services being purchased;
providing the goods or services to the purchaser; and
receiving payment for the goods or services from the balance associated with the code.

7. The method of claim 6 wherein the computerized network comprises the Internet.

8. The method of claim 6 wherein receiving a code comprises receiving a code via the Internet from a site configured to sell goods or services.

9. The method of claim 6 wherein analyzing the code comprises initiating a data base look-up to determine the status of the code.

10. The method of claim 6 wherein the balance indicates the monetary value of goods that may be obtained using the code.

11. The method of claim 6 wherein receiving payment comprises receiving payment from an entity responsible for the balance associated with the code.

12. A method for directing consumers to a particular Internet site comprising:
establishing one or more sites as a code activation sites;
directing a consumer to at least one of the one or more code activation sites;
receiving a code to be activated from at least one of the one or more code activation sites;
activating the code at a code database;

13. The method of claim 12 further including transmitting a message to at least one code activation site that the code is activated.

14. The method of claim 12 wherein directing a consumer comprises printing an address of an activation site on a card, the card containing the code.

15. The method of claim 12 wherein establishing one or more sites as a code activation sites comprises installing software at said site to initiate a code activation process.

16. The method of claim 12 further including analyzing the code to verify that the code is valid.

17. A system for facilitating transactions over a computer network based on pre-purchased verifiable codes having a monetary balance associated therewith, said system comprising:
a computer having:
data storage configured to store information regarding the codes and the monetary balance associated with each code;
a communication interface configured to communicate with a computer network;
a processor;
computer program configured to execute on the processor and control the data storage and the communication interface, the computer program further configured to communication with other computers on the computer network to verify the validity of one or more codes and an associated balance wherein the codes do not identify an individual associated with the code.

18. The system of claim 17 wherein the computer network comprises the Internet.

19. The system of claim 17 wherein data storage comprises a hard disk drive.

20. The system of claim 17 wherein verify the validity comprises performing a data base look-up to determine if the code is valid.

21. The system of claim 17 wherein the computer program also receives one or more messages from one or more other computers on the network to activate the code.

22. The system of claim 17 wherein the processor is in communication with the data storage and the communication interface.

23. The system of claim 17 wherein the communication interface is in communication with the processor to facilitate communication over a computerized network, the communication interface configured to interface with other processors.

24. The system of claim 17 whereby the processor, the data storage, and the communication interface are configured to communicate to a third party the amount of money represented by the code and record deductions to the amount of money represented by the code in response to purchases.

25. A computer program product comprising a computer usable medium having computer program logic recorded thereon for providing an automated commerce system for use by a entity desiring to purchase goods or services over a computer network using codes that have currency values associated therewith, the computer program product comprising:
computer program code logic configured to receive from a merchant over a computer network a request for code validation and an account balance associated with the code;
computer program code logic configured to verify the code is a valid code and obtain information regarding the account balance associated with the code;
computer program code logic configured to respond over a computer network to the merchant regarding the validity of the code and the account balance.

26. The computer program of claim 25 further including computer program code logic configured to activate the code based on communications from one or more predetermined computers on the computer network.

27. The computer program of claim 25 further including computer program code logic configured to update the account by deducting the amount of a purchase from the account balance.

28. The computer program of claim 25 further including computer program code logic configured to initiate payment from the account associated with the code to the merchant.

29. The computer program of claim 25 further including computer program code logic configured to invalidate the code when the account balance associated with the code reaches zero.

30. The computer program of claim 25 further including computer program code logic configured to initiate payment to the code owner when the account balance associated with the code falls below a predetermined limit.
